(19) United States
(12) Patent Application Publication
(10) Pub. No.: US 2026/0205285 A1
(43) Pub. Date: Jul. 16, 2026

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Ryosuke NAKAI, Kanagawa (JP); Masahiko HARADA, Kanagawa (JP); Atsushi MORI, Kanagawa (JP); Sho NAGASE, Kanagawa (JP)

(73) Assignee: FUJIFILM Business Innovation Corp., Tokyo (JP)

(21) Appl. No.: 19/307,099

(22) Filed: Aug. 22, 2025

(30) Foreign Application Priority Data
Jan. 15, 2025 (JP) 2025-005329

(51) Int. Cl. H04L 9/08; G06F 13/42

(52) U.S. Cl. CPC H04L 9/088; G06F 13/4282; G06F 2213/0016

(57) ABSTRACT

An information processing apparatus includes: a first board; and a second board, the first board and the second board being connected via a communication line, the first board including a first processor, a first memory device that is removable, and a second memory device that is not removable, the first memory device being a memory device moved from a third board that has undergone replacement with the first board, the first memory device storing first encrypted data encrypted with a first encryption key unique to the third board, the second board including a second processor and a third memory device, the third memory device storing the first encryption key backed up before the replacement of the third board with the first board, the first processor being configured to: in response to a failure in communication between the first board and the second board, copy the first encrypted data from the first memory device into the second memory device; initialize the first memory device and write, to the first memory device, parameter information required for the communication with the second board; establish the communication with the second board by using the parameter information; and acquire the first encryption key from the second board with which the communication is established and store the first encryption key in the first board.

### CROSS-REFERENCE TO RELATED APPLICATIONS

This application is based on and claims priority under 35 USC 119 from Japanese Patent Application No. 2025-005329 filed Jan. 15, 2025.

### BACKGROUND

### (i) Technical Field

The present disclosure relates to an information processing apparatus, a non-transitory computer readable medium, and an information processing method.

### (ii) Related Art

High security for user data is required for printers and other devices. For example, the following conditions are thus required to be satisfied.
(1) Data in the removable memory device is encrypted using a specific algorithm.
(2) A plaintext encryption key used for the encryption is prohibited from being stored in the same memory device as that for the encrypted data.
(3) The plaintext encryption key is prohibited from being stored in a removable memory device.

Examples of the related art include, for example, Japanese Unexamined Patent Application Publication No. 2008-236089.

### SUMMARY

When being repaired, a printer and other apparatuses need to undergo board replacement on occasions. In this case, a memory device is removed from an old board and moved into a new board.

If an encryption key for the old board has been backed up in a different memory device present on the same bus as that for the new board, it is possible to decrypt encrypted data in the memory device moved into the new board by using the backed up encryption key.

However, if the different memory device on the same bus as that for the new board is removable, using the different memory device is not allowed to back up a plaintext encryption key. In this case, a memory device attached to a different board connected to the new board via a communication line serves as a possible backup destination.

However, for communication of the new board with the different board, parameter information encrypted and stored in the memory device moved into the new board is required. However, the encryption key for the old board is not present in the new board. For this reason, it is not possible to decrypt the parameter information and not possible to communicate with the different board. Accordingly, it is not possible to read the encryption key backed up in the different board out to the new board and not possible to decrypt encrypted data in the memory device taken over from the old board.

Aspects of non-limiting embodiments of the present disclosure relate to enabling communication from a new board to a different board to be established without the need for user operation even in a case where parameter information required to establish the communication with the different board is taken over to the new board in a state where the parameter information is encrypted with an encryption key for an old board.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a first board; and a second board, the first board and the second board being connected via a communication line, the first board including a first processor, a first memory device that is removable, and a second memory device that is not removable, the first memory device being a memory device moved from a third board that has undergone replacement with the first board, the first memory device storing first encrypted data encrypted with a first encryption key unique to the third board, the second board including a second processor and a third memory device, the third memory device storing the first encryption key backed up before the replacement of the third board with the first board, the first processor being configured to: in response to a failure in communication between the first board and the second board, copy the first encrypted data from the first memory device into the second memory device; initialize the first memory device and write, to the first memory device, parameter information required for the communication with the second board; establish the communication with the second board by using the parameter information; and acquire the first encryption key from the second board with which the communication is established and store the first encryption key in the first board.

### BRIEF DESCRIPTION OF THE DRAWINGS

Exemplary embodiments of the present disclosure will be described in detail based on the following figures, wherein:

FIG. 1 is a view for explaining an example configuration of an image forming apparatus;

FIG. 2 is a view for explaining an example internal configuration of a main board and sub boards;

FIG. 3 is a view for explaining example data stored in memory devices;

FIG. 4 is a view for explaining example functional programs to run on the main board;

FIG. 5 is a view for explaining replacement work for a main board;

FIG. 6 is a flowchart for explaining an example of start processing not involving the replacement of the main board;

FIG. 7 is a flowchart for explaining an example of start processing involving the replacement of the main board;

FIG. 8 is a view for explaining processing operation in step S108 in FIG. 7;

FIG. 9 is a view for explaining the restoration of a backed-up encryption key (old);

FIG. 10 is a view for explaining the restoration of encrypted and backed-up data to a master nonvolatile memory;

FIG. 11 is a view for explaining a different example internal configuration of the main board and the sub boards;

FIG. 12 is a view for explaining different example data stored in a memory device in the sub board; and

FIG. 13 is a view for explaining storing encryption keys in storing, in the master nonvolatile memory, encrypted data encrypted with an encryption key (new) unique to a new main board (new).

### DETAILED DESCRIPTION

Hereinafter, exemplary embodiments of the present disclosure will be described with reference to the drawings.

### Exemplary Embodiment 1

### Configuration of Image Forming Apparatus

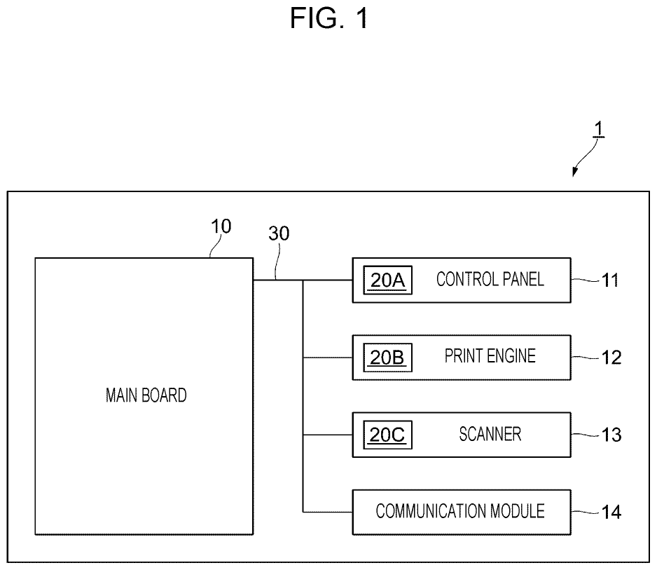

FIG. 1 is a view for explaining an example configuration of an image forming apparatus The image forming apparatus 1 is an example of an information processing apparatus.

The image forming apparatus 1 includes, for example, a main board 10, a control panel 11, a print engine 12, a scanner 13, and a communication module 14.

The main board 10 performs overall control of the processing and operations of the apparatus through communication with the control panel 11, the print engine 12, the scanner 13, and the communication module 14.

The main board 10 is an example of a control board. The main board 10 is also an example of a first board.

The main board 10 is connected to the control panel 11, the print engine 12, the scanner 13, and the communication module 14 via a communication line 30. The communication line 30 complies with, for example, the inter integrated circuit (I2C) method. I2C is an example of synchronous serial communication. The communication line 30 is used for the synchronous serial communication and thus has a signal line for data and a signal line for the clock.

The control panel 11 is a device that receives operation and input from a user. The control panel 11 is an example of a user interface. In this exemplary embodiment, the control panel 11 is independent of the print engine 12 and other devices. The control panel 11 is provided with a sub board 20A that controls internal processing.

The sub board 20A is also an example of the control board. The sub board 20A is also an example of a second board. The sub board 20A is also an example of a user interface board.

As operators of the control panel 11, for example, a touch panel, buttons, and switches are provided.

The touch panel is a device having a structure in which, for example, an electrostatic capacitance translucent thin film sensor is stacked on the surface of the display. The touch panel has functions of both of an input device and an output device. Hereinafter, any of various screens displayed on the touch panel is also referred to as an operation screen.

A button and a switch are an example of a mechanical operator.

The print engine 12 includes a device that controls printing of information on paper and other media and a mechanism used to print the information on the medium. The print engine 12 is an example of an image output unit. The print engine 12 is independent of the control panel 11 and other devices. The print engine 12 is provided with a sub board 20B that controls the internal processing.

The sub board 20B is also an example of the control board. The sub board 20B is also an example of the second board. The sub board 20B is also an example of a board of the image output unit.

The sub board 20B performs processing related to, for example, rasterization, density correction, sharpness correction, contrast correction, and base color removal. The mechanism of the print engine 12 differs depending on the printing system. For example, the mechanism of the print engine 12 differs between a photographic printing system and an inkjet system. Depending on whether the medium is cut paper or a paper roll, a mechanism for transporting the medium (that is, a transportation mechanism) differs.

The scanner 13 is a device that optically reads information on the surface of a document. The scanner 13 is an example of an image reading unit. In this exemplary embodiment, the scanner 13 is independent of the control panel 11 and other devices. The scanner 13 is provided with a sub board 20C that controls the internal processing.

The sub board 20C is also an example of the control board. The sub board 20C is also an example of the second board. The sub board 20C is also an example of a board of an image reading unit.

The scanner 13 supports at least one of a method by which a reading part is moved relative to a document in a stationary state and a method by which a document is moved relative to the reading part in the stationary state.

The communication module 14 is a module that implements communication with external terminals (for example, a desktop computer, a server, and a smartphone).

The communication module 14 includes, for example, a module used for wired or wireless connection to a local area network (LAN). The communication module 14 also includes, for example, a universal serial bus (USB) module.

### Internal Configuration of Control Board

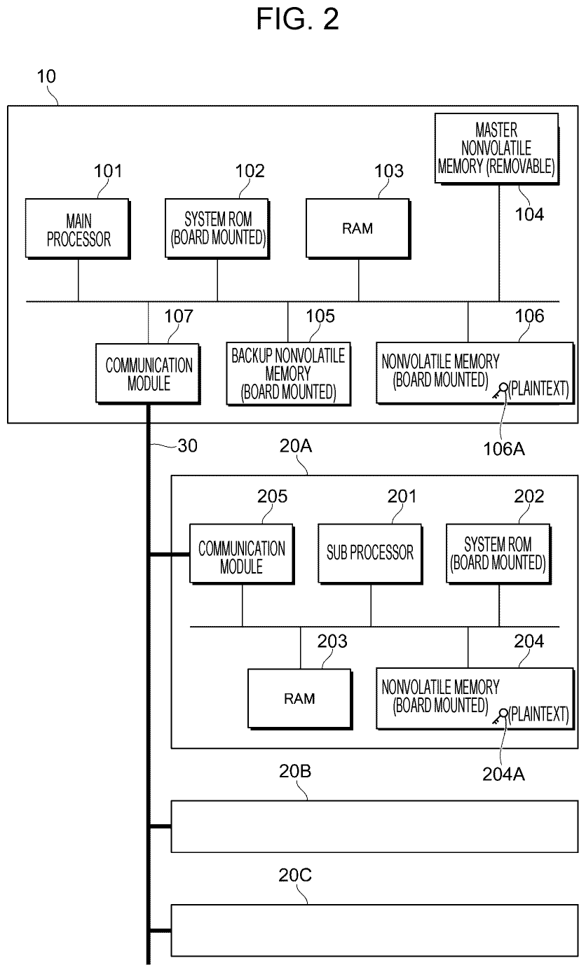

FIG. 2 is a view for explaining an example internal configuration of the main board 10 an the sub boards 20A, 20B, and 20C. The components illustrated in FIG. 2 are denoted by references corresponding to those in FIG. 1.

FIG. 2 illustrates the internal configuration of the sub board 20A as a representative. The internal configuration of the sub boards 20B and 20C in this exemplary embodiment is the same as that of the sub board 20A.

Hereinafter, when not being discriminated from each other, the sub boards 20A, 20B, and 20C are referred to as a sub board 20.

The main board 10 includes, for example, a main processor 101, a system read only memory (ROM) 102, a random access memory (RAM) 103, a master nonvolatile memory 104, a backup nonvolatile memory 105, a nonvolatile memory 106, and a communication module 107.

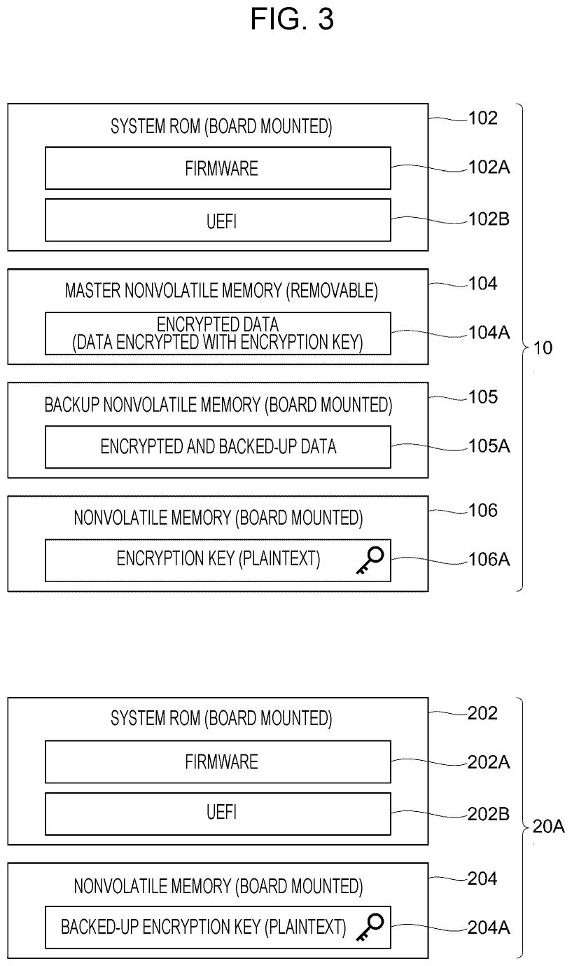

The main processor 101 is a semiconductor device that implements various functions through the running of a program. The main processor 101 is an example of a first processor. The program herein includes, for example, firmware 102A (see FIG. 3) and a unified extensible firmware interface (UEFI) 102B (see FIG. 3).

The firmware 102A is a program for performing overall control of the processing and operations of the apparatus. The UEFI 102B is a boot program for controlling a start process.

The system ROM 102 is mounted on the main board 10. The system ROM 102 is thus a memory device that is not physically removable from the main board 10 by a customer engineer or the like. The system ROM 102 is, for example, soldered onto the main board 10.

The RAM 103 is a semiconductor memory, for example, used as a program running area For example, a computer is composed of the main processor 101, the system ROM 102, and the RAM 103. The RAM 103 is also mounted on the main board 10.

The master nonvolatile memory 104 is a memory device removable from the main board 10. The master nonvolatile memory 104 includes, for example, a secure digital (SD) memory card, a hard disk device (that is, a magnetic recording device), and a ROM soldered onto a sub board connected to the main board 10 with connectors.

In this exemplary embodiment, the master nonvolatile memory 104 stores data encrypted with an encryption key 106A (see FIG. 3) (that is, encrypted data 104A). The master nonvolatile memory 104 is an example of a first memory device.

The backup nonvolatile memory 105 is a memory device mounted on the main board 10. The backup nonvolatile memory 105 includes, for example, an electrically erasable programmable (EEP) ROM, a flash ROM, and a trusted platform module (TPM).

The backup nonvolatile memory 105 is used as a backup memory of the master nonvolatile memory 104. The backup nonvolatile memory 105 thus stores copy of the encrypted data 104A. The backup nonvolatile memory 105 is an example of a second memory device.

The nonvolatile memory 106 is a memory device mounted on the main board 10. The nonvolatile memory 106 includes, for example, an EEPROM, a flash ROM, and a TPM.

In this exemplary embodiment, the nonvolatile memory 106 stores the encryption key 106A written in plaintext used for the encryption of the encrypted data 104A. The plaintext encryption key 106A is an example of a first encryption key. The plaintext encryption key 106A is prohibited from being stored in the same memory device as that for the encrypted data 104A.

The communication module 107 is a module that implements communication between the main board 10 and the sub board 20. The communication module 107 is thus a module that implements communication via the communication line 30. Accordingly, the communication module 107 complies with the I2C standard.

The devices in the main board 10 are connected to the same bus. The main processor 101, the system ROM 102, the RAM 103, the master nonvolatile memory 104, the backup nonvolatile memory 105, the nonvolatile memory 106, and the communication module 107 are thus present on the same bus.

The sub board 20A includes, for example, a sub processor 201, a system ROM 202, a RAM 203, a nonvolatile memory 204, and a communication module 205.

The sub processor 201 is a semiconductor device that implements various functions by running a program. The sub processor 201 is an example of a second processor. The program herein includes, for example, firmware 202A (see FIG. 3) and a UEFI 202B (see FIG. 3).

The firmware 202A is a program for controlling the processing and operations of modules for the sub board 20. The UEFI 202B is a boot program for controlling a startup process.

The main board 10 and the sub board 20A in this exemplary embodiment are started independently in response to the main power being turned on.

The system ROM 202 is mounted on the sub board 20A. The system ROM 202 is thus a memory device that is not physically removable from the sub board 20A by the customer engineer or the like. The system ROM 202 is, for example, soldered onto the sub board 20A.

The RAM 203 is a semiconductor memory used as, for example, a program running area For example, a computer is composed of the sub processor 201, the system ROM 202, and the RAM 203. The RAM 203 is also mounted on the sub board 20A.

The nonvolatile memory 204 is a memory device mounted on each sub board 20. The nonvolatile memory 204 includes, for example, an EEPROM, a flash ROM, and a TPM.

In this exemplary embodiment, the nonvolatile memory 204 in the sub board 20A is used for a backup area for the encryption key 106A, and the nonvolatile memory 204 of each of the sub boards 20B and 20C is used for another purpose.

The nonvolatile memory 204 is an example of a third memory device. A backed-up encryption key 204A backed up in the nonvolatile memory 204 is an example of the first encryption key.

The communication module 205 is a module that implements communication between the main board 10 and the sub board 20. The same type of module as the communication module 107 in the main board 10 is used for the communication module 205. The communication module 205 is used to communicate with the communication module 107 in the main board 10. Accordingly, the communication module 205 complies with the I2C method.

In this exemplary embodiment, the main board 10 operates as a master, and the sub board 20 operates as a slave.

As described above, the main board 10 and the sub board 20 are connected via the communication line 30. Accordingly, the communication module 107 and the communication module 205 are not present on the same bus. Accordingly, the communication between the communication module 107 and the communication module 205 is required to be established in the start processing.

Setting information required to establish the communication has been encrypted and stored in the master nonvolatile memory 104.

### Data Stored in Memory Device

FIG. 3 is a view for explaining example data stored in the memory devices. The components illustrated in FIG. 3 are denoted by references corresponding to those in FIGS. 1 and 2.

The system ROM 102 in the main board 10 stores the firmware 102A and the UEFI 102B

The master nonvolatile memory 104 removable from the main board 10 stores the encrypted data 104A. The encrypted data 104A includes the setting information encrypted with, for example, the encryption key 106A unique to the main board 10.

The setting information includes, for example, user information and security information. The user information includes, for example, information identifying a user, parameter information required to communicate with the sub board 20 (hereinafter, also referred to as communication setting), setting regarding a user for one of various functions, a usage log, and an error log. The security information includes, for example, a text string (for example, an identity) unique to the main board 10. The identity is provided as, for example, a serial number.

In addition, the master nonvolatile memory 104 may include data that is not encrypted (that is, unencrypted data). The unencrypted data includes, for example, an initial value of a parameter used to communicate with the sub board 20.

The backup nonvolatile memory 105 mounted on the main board 10 stores encrypted and backed-up data 105A of the encrypted data 104A. The backup nonvolatile memory 105 may also include backup data of the unencrypted data.

The nonvolatile memory 106 mounted on the main board 10 stores the plaintext encryption key 106A. The requirement that the encrypted data 104A and the plaintext encryption key 106A used for the encryption of the encrypted data 104A are prohibited from being stored in the same memory device is thereby satisfied.

The system ROM 202 of the sub board 20A stores the firmware 202A and the UEFI 202B. A system ROM 202 of each of the sub boards 20B and 20C (not illustrated) (see FIG. 1) also stores the firmware 202A and the UEFI 202B.

The nonvolatile memory 204 mounted on the sub board 20A stores the backed-up encryption key 204A written in plaintext.

The backed-up encryption key 204A is restored to the nonvolatile memory 204 by the main processor 101 after the communication between the communication module 107 (see FIG. 2) and the communication module 205 (see FIG. 2) is established.

In this exemplary embodiment, the backed-up encryption key 204A is not stored in the nonvolatile memory 204 of the sub boards 20B and 20C (not illustrated) (see FIG. 1).

Nevertheless, the backed-up encryption key 204A may be stored in the nonvolatile memory 204 of any of the sub boards 20B and 20C (not illustrated) (see FIG. 1). The backed-up encryption key 204A may thus be stored in multiple sub boards 20.

### Functional Programs to Run on Main Board

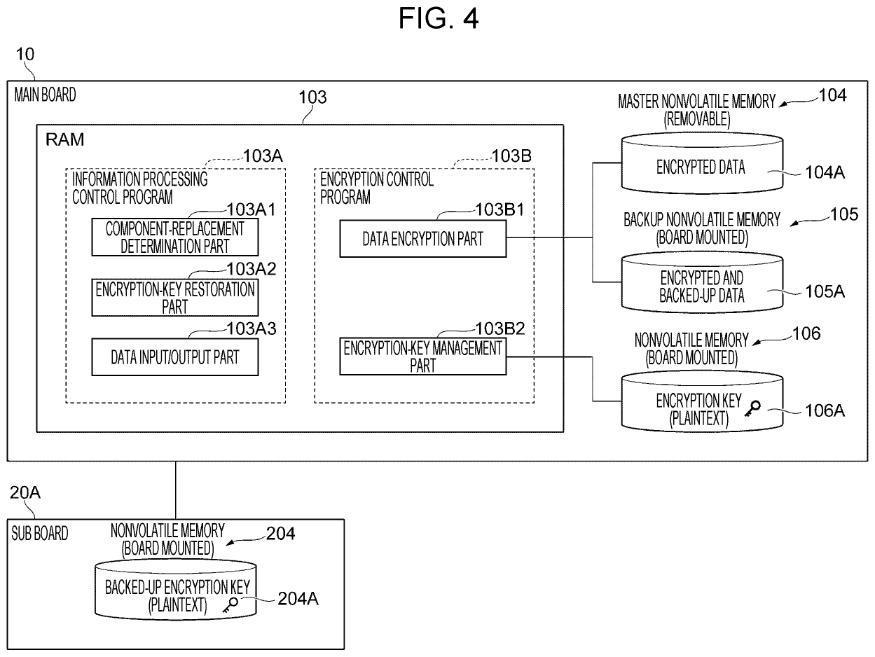

FIG. 4 is a view for explaining example functional programs to run on the main board 10. The components illustrated in FIG. 4 are denoted by references corresponding to those in FIG. 3.

FIG. 4 illustrates a state where the functional programs are loaded into the RAM 103. The functional programs each correspond to a corresponding one of the firmware 102A (see FIG. 3) and the UEFI 102B (see FIG. 3).

FIG. 4 illustrates two programs that are an information processing control program 103A and an encryption control program 103B.

The information processing control program 103A includes three sub programs. In FIG. 4, the information processing control program 103A includes a component-replacement determination part 103A1, an encryption-key restoration part 103A2, and a data input/output part 103A3.

The information processing control program 103A corresponds to the UEFI 102B (see FIG. 3).

The component-replacement determination part 103A1 is a functional program for determining whether the main board 10, the sub board 20, the master nonvolatile memory 104, or the like has been replaced.

The component-replacement determination part 103A1 determines whether the main board 10 has been replaced, by using data stored in, for example, a specific area of the master nonvolatile memory 104. For example, if a text string decrypted from the data in the specific area is different from a known text string (the serial number unique to the main board 10), it is determined that the main board 10 has been replaced.

The encryption-key restoration part 103A2 is a functional program for backing up the encryption key 106A in the sub board 20 and restoring the backed-up encryption key 204A to the main board 10. The encryption-key restoration part 103A2 also has a function of initializing the master nonvolatile memory 104 in establishing the communication between the main board 10 and the sub board 20. The initialization causes the data stored in the master nonvolatile memory 104 to be erased. The initialization also causes the setting information including the parameter information to be written to the master nonvolatile memory 104.

The data input/output part 103A3 is a functional program for performing inputting and outputting data in the main board 10 and inputting and outputting data to and from the sub board 20.

The encryption control program 103B includes two functional programs. In FIG. 4, the encryption control program 103B includes a data encryption part 103B1 and an encryption-key management part 103B2. The encryption control program 103B corresponds to the firmware 102A (see FIG. 3).

The data encryption part 103B1 is a functional program for encrypting and decrypting user data including setting information.

The encryption-key management part 103B2 is a functional program for managing the encryption key 106A to be stored in the nonvolatile memory 106. The encryption-key management part 103B2 regards, as a valid encryption key, the encryption key 106A enabling the encrypted data 104A to be decrypted correctly.

### Replacement Work and Processing Operations of Control Board

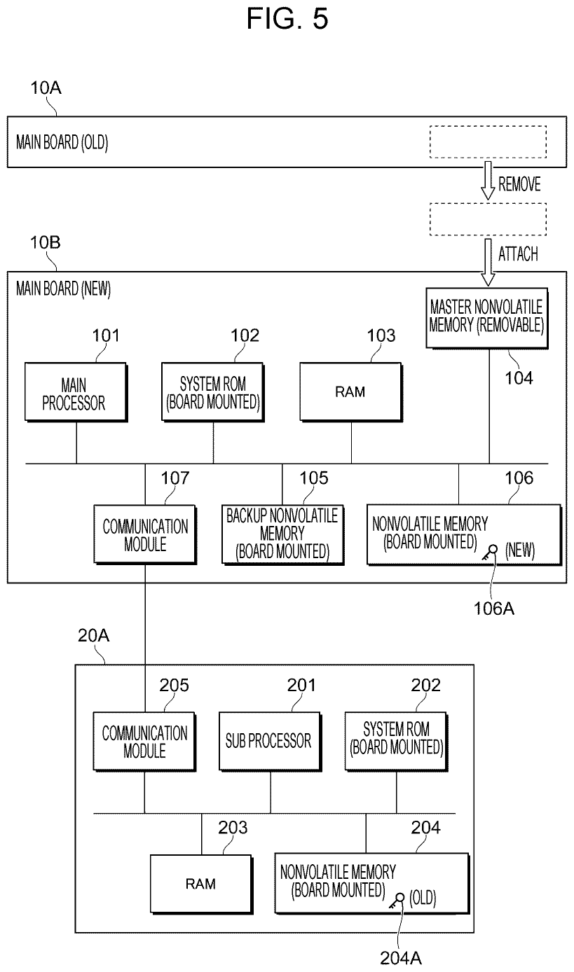

FIG. 5 is a view for explaining replacement work for the main board 10 (see FIG. 1). The components illustrated in FIG. 5 are denoted by references corresponding to those in FIG. 2.

For example, the customer engineer removes the master nonvolatile memory 104 from the failed main board 10 (hereinafter, referred to as a main board (old) 10A) and attaches the master nonvolatile memory 104 to a different main board 10 (hereinafter, referred to as a main board (new) 10B).

As described above, the master nonvolatile memory 104 is removable from the main board (old) 10A.

The main board (old) 10A herein is an example of a third board. The master nonvolatile memory 104 of the main board (old) 10A stores data encrypted with the encryption key unique to the main board (old) 10A (hereinafter, referred to as an encryption key (old)) 106A. The master nonvolatile memory 104 thus stores the encrypted data 104A (see FIG. 3) used for the main board (old) 10A.

The encryption key (old) 106A unique to the main board (old) 10A is an example of the first encryption key. The encrypted data 104A is an example of first encrypted data encrypted with the first encryption key.

In FIG. 5, to clarify the relationship between the encryption key and the old and new main boards 10, an encryption key for the main board (old) 10A before the replacement is referred to as the encryption key (old), and an encryption key for the main board (new) 10B after the replacement is referred to as an encryption key (new).

The nonvolatile memory 106 of the main board (new) 10B thus stores an encryption key (new) 106A. In contrast, the sub board 20A stores the backed-up encryption key (old) 204A backed up from the main board (old) 10A.

As illustrated in FIG. 5, only the encryption key (new) 106A is present in the main board (new) 10B, and the encryption key (old) 106A is not present therein. The encryption key (new) 106A is not used to encrypt the encrypted data 104A.

Accordingly, it is not possible to decrypt a correct text string from the encrypted data 104A stored in the master nonvolatile memory 104.

Incidentally, the sub board 20A connected to the main board (new) 10B via the communication line 30 stores the backed-up encryption key (old) 204A backed up before the replacement of the main board 10. Hereinafter, the backed-up encryption key 204A is also referred to as the backed-up encryption key (old) 204A.

### Start Processing

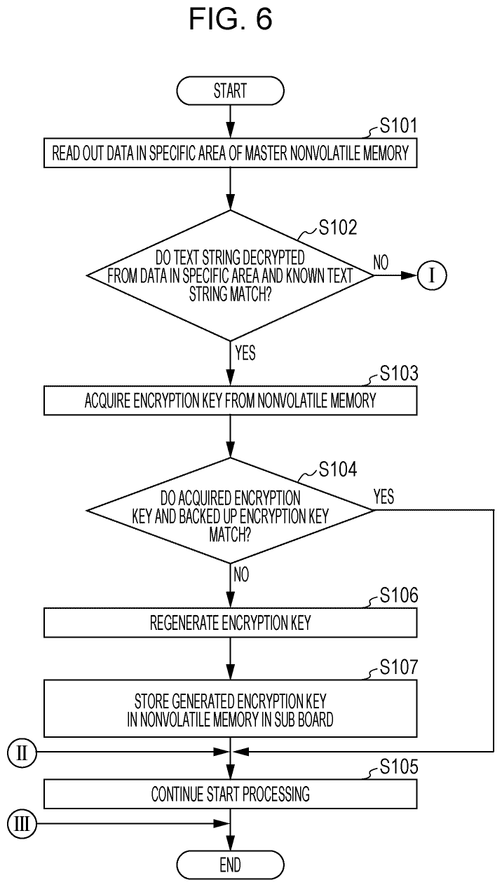

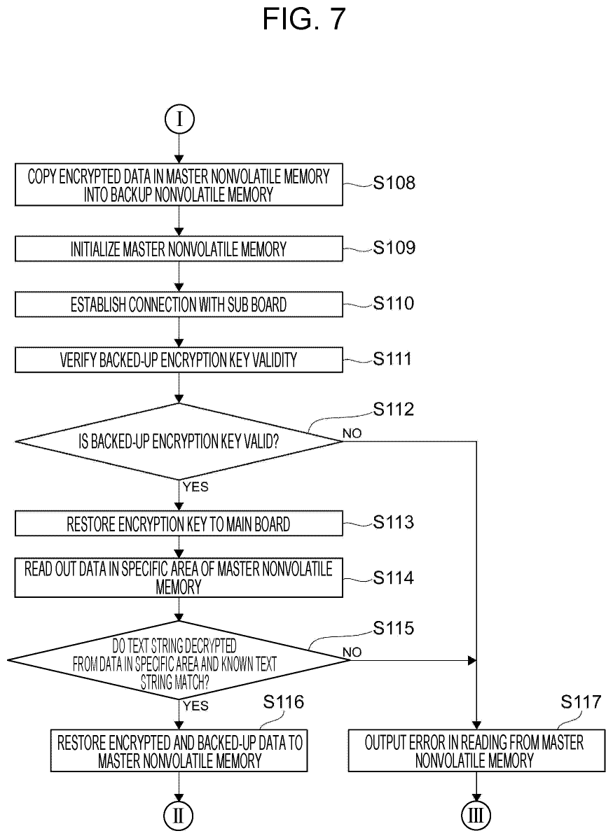

FIG. 6 is a flowchart for explaining an example of start processing not involving the replacement of the main board 10 (see FIG. 1). FIG. 7 is a flowchart for explaining an example of start processing involving the replacement of the main board 10 (see FIG. 1). The letters S in FIGS. 6 and 7 each denote a step.

The processing operation illustrated in FIG. 6 is performed when the main power of the image forming apparatus 1 (see FIG. 1) is turned on. Turning on the main power causes the UEFI 102B (see FIG. 3) to execute the boot process. Specifically, the component-replacement determination part 103A1 (see FIG. 4) is run.

First, the main processor 101 (see FIG. 2) reads out data in a specific area of the master nonvolatile memory 104 (see FIG. 3) by using the data input/output part 103A3 (see FIG. 4) (step S101).

The main processor 101 then determines whether a text string decrypted from the data in the specific area and a known text string match (step S102). The determination is performed by the component-replacement determination part 103A1 (see FIG. 4).

If the decrypted text string and the known text string match, step S102 has an affirmative result. For example, if the main board 10 (see FIG. 2) has not been replaced, step S102 has the affirmative result. Since the main board 10 has not been replaced, it is possible to decrypt the encrypted data 104A with the encryption key 106A stored in the nonvolatile memory 106 (see FIG. 2). Decrypting the encrypted data 104A (see FIG. 3) also causes parameter information required to establish the communication with the sub board 20 (see FIG. 1) to be decrypted correctly.

The communication between the main board 10 and the sub board 20 is established by using the decrypted parameter information or the like. The communication between the main board 10 and the sub board 20 is thus enabled.

The main processor 101 then acquires the encryption key 106A (see FIG. 2) from the nonvolatile memory 106 (see FIG. 2) (step S103).

The main processor 101 subsequently determines whether the acquired encryption key 106A (see FIG. 4) and the backed-up encryption key (old) 204A thus backed up (see FIG. 4) match (step S104).

The determination is performed by the component-replacement determination part 103A1 (see FIG. 4). In the determination, for example, a text string for the encryption key 106A is compared with a text string for the backed-up encryption key (old) 204A.

If the two encryption keys match, step S104 has an affirmative result. If any component has not been replaced, the two encryption keys match. In this case, the main processor 101 continues the start processing (step S105).

In contrast, if the two encryption keys do not match, step S104 has a negative result. If the two encryption keys do not match, for example, the sub board 20 possibly has been replaced. In this case, the main processor 101 regenerates the encryption key 106A (step S106).

For example, an identity is read out into the main board 10, and the encryption key 106A unique to the main board 10 is regenerated. To generate the encryption key 106A unique to the main board 10, for example, the serial number of the main board 10 is used. The regenerated encryption key 106A matches with the encryption key 106A used to generate the encrypted data 104A stored in the master nonvolatile memory 104.

The main processor 101 then stores the generated encryption key 106A in the sub board 20 in the nonvolatile memory 204 (see FIG. 4) (step S107).

The main processor 101 thereafter continues the start processing (step S105).

The description is provided back to step S102 (see FIG. 6).

If the text string decrypted from the data in the specific area and the known text string do no match, step S102 has a negative result. For example, if the main board (old) 10A is replaced, and if the master nonvolatile memory 104 is attached to the main board (new) 10B, the two text strings do not match. In this case, the main processor 101 copies the encrypted data 104A of the master nonvolatile memory 104 (see FIG. 3) into the backup nonvolatile memory 105 (step S108). In other words, the encrypted data 104A of the master nonvolatile memory 104 (see FIG. 3) is saved in the backup nonvolatile memory 105.

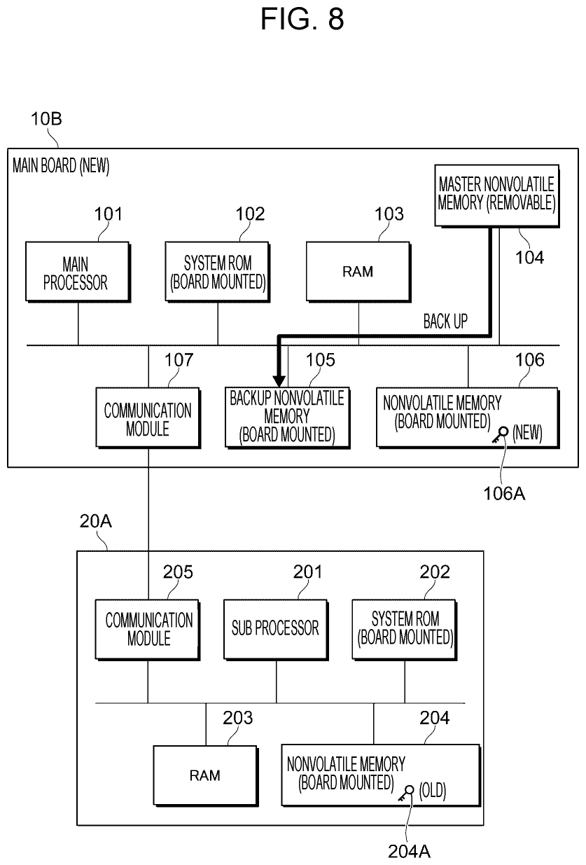

FIG. 8 is a view for explaining the processing operation in step S108 in FIG. 7. The components illustrated in FIG. 8 are denoted by references corresponding to those in FIG. 5. As illustrated in FIG. 8, the encrypted data 104A stored in the master nonvolatile memory 104 taken over from the main board (old) 10A is backed up in the backup nonvolatile memory 105 in the same board. The backup is implemented by using, for example, the data input/output part 103A3 (see FIG. 4).

The description is provided back to FIG. 7.

Upon completion of the backup of the encrypted data 104A, the main processor 101 initializes the master nonvolatile memory 104 (step S109). In initializing the master nonvolatile memory 104, the parameter information or the like required for the communication with, for example, the sub board 20 is newly written to the master nonvolatile memory 104. In this exemplary embodiment, the parameter information or the like required for the communication with the sub board 20 is written in a state where the parameter information or the like is encrypted with, for example, the encryption key (new) 106A unique to the main board (new) 10B. The encryption key (new) 106A is an example of a second encryption key.

The main processor 101 then establishes connection with the sub board 20 (step S110). If the connection with the sub board 20 is established, the nonvolatile memory 204 (see FIG. 8) storing the backed-up encryption key (old) 204A (see FIG. 5) becomes accessible.

The main processor 101 subsequently verifies the validity of the backed-up encryption key (old) 204A (step S111). The verification is performed by the encryption-key restoration part 103A2.

For example, the main processor 101 compares the identity stored in the master nonvolatile memory (old) 104 with an identity stored in the nonvolatile memory 204 storing the backed-up encryption key (old) 204A. The identity in the master nonvolatile memory (old) 104 is provided as, for example, the serial number unique to the image forming apparatus 1. The identity in the nonvolatile memory 204 is provided as, for example, an identity unique to the image forming apparatus 1.

The main processor 101 subsequently determines whether the backed-up encryption key (old) 204a is valid (step S112).

If the two identities match, the backed-up encryption key (old) 204A is considered to be valid. If the two identities do not match, the backed-up encryption key (old) 204A is considered to be invalid.

If the backed-up encryption key (old) 204A is valid, step S112 has an affirmative result. In this case, the main processor 101 restores the backed-up encryption key (old) 204A to the main board (new) 10B (step S113). Specifically, the backed-up encryption key (old) 204A is written to the nonvolatile memory 106.

If the backed-up encryption key (old) 204A is invalid, step S112 has a negative result. In this case, the main processor 101 proceeds to step S117 to be described later.

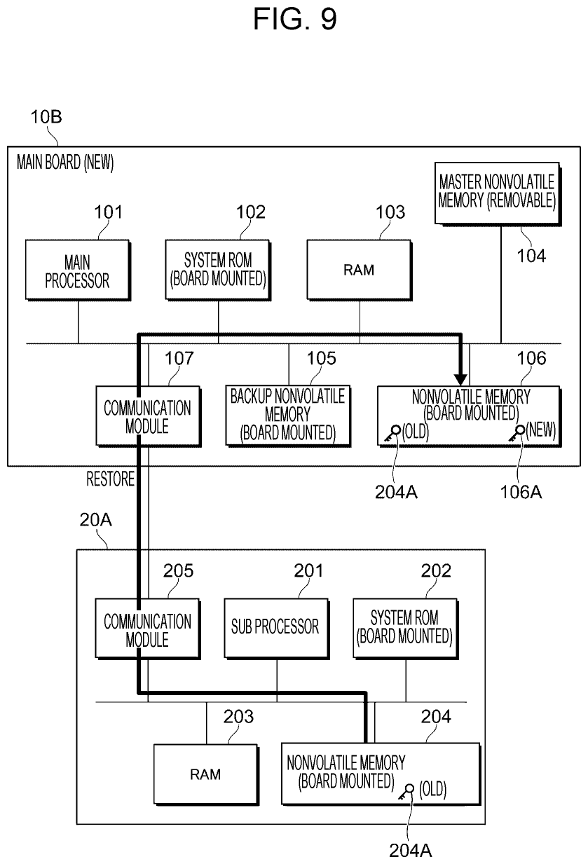

FIG. 9 is a view for explaining the restoration of the backed-up encryption key (old) 204A. The components illustrated in FIG. 9 are denoted by references corresponding to those in FIG. 8.

As the result of the restoration of the backed-up encryption key (old) 204A, the encryption key (new) 106A is added to the nonvolatile memory 106.

The main processor 101 then reads out data in the specific area of the master nonvolatile memory 104 (step S114). The specific area stores data encrypted with the encryption key (new) 106A due to the initialization in step S109. The data in the specific area is decrypted with the encryption key (new) 106A stored in the nonvolatile memory 106. This enables a correct text string to be decrypted.

Thereafter, the main processor 101 determines whether the text string decrypted from the data in the specific area and a known text string match (step S115). The determination is the same as that in step S102 (see FIG. 6). The determination is thus performed by the component-replacement determination part 103A1 (see FIG. 4).

If the read text string and the known text string match, step S115 has an affirmative result. In this case, the main processor 101 restores the encrypted and backed-up data 105A (see FIG. 3) to the master nonvolatile memory 104 (see FIG. 9) (step S116).

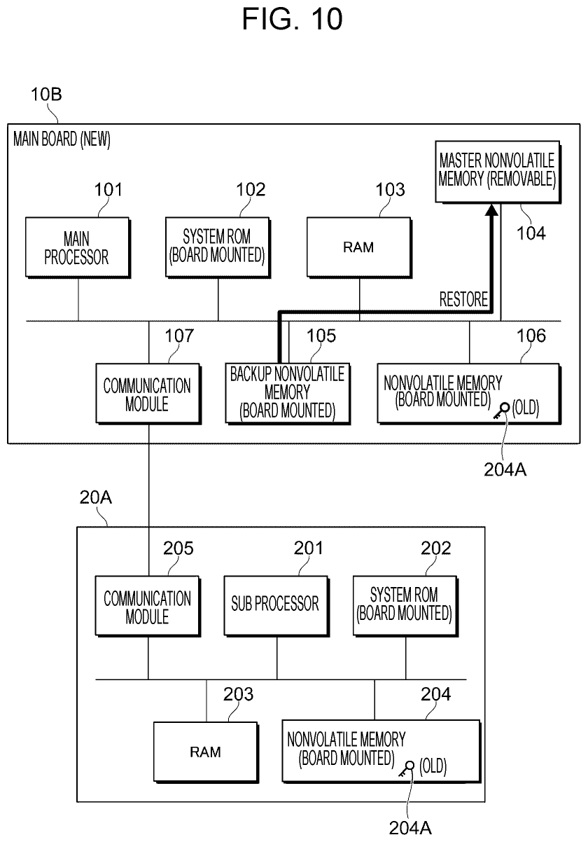

FIG. 10 is a view for explaining the restoration of the encrypted and backed-up data 105A (see FIG. 3) to the master nonvolatile memory 104. The components illustrated in FIG. 10 are denoted by references corresponding to those in FIG. 9.

The encrypted data 104A stored immediately after the attachment to the main board (new) 10B has been erased due to the initialization in step S109. However, a state immediately after the attachment to the main board (new) 10B is reproduced in the master nonvolatile memory 104 due to the restoration of the encrypted and backed-up data 105A. Incidentally, the parameter information encrypted with the encryption key (new) 106A has been stored in the master nonvolatile memory 104 due to the initialization in step S109.

In this exemplary embodiment, the parameter information in the master nonvolatile memory 104 is decrypted with the encryption key (new) 106A and thereafter encrypted again with the backed-up encryption key (old) 204A (that is, the encryption key (old) 106A). This also enables the parameter information to be read out on and after the next start-up.

The main processor 101 thereafter deletes the encryption key (new) 106A from the nonvolatile memory 106. FIG. 10 represents a state where the encryption key (new) 106A is deleted.

The main processor 101 thereafter continues the start processing (step S105).

In contrast, if the decrypted text string and the known text string do not match, step S115 has a negative result. The inconsistency occurs, for example in a case of incorrect combination of the main board 10 having the master nonvolatile memory 104 attached thereto and the sub board 20.

This occurs, for example, if the master nonvolatile memory 104 is attached to the main board (new) 10B connected to a sub board 20 that is different from the sub board 20 connected to the main board (old) 10A. In this case, the main processor 101 outputs an error in reading from the master nonvolatile memory 104 (step S117) and terminates the start processing.

The case of the negative result in step S112 described above is the same as the case of the negative result in step S115.

### Summing Up

In replacing the main board 10, the parameter information required to establish the communication with the sub board 20A is taken over to the main board (new) 10B in the state where the parameter information is encrypted with the encryption key (old) 106A of the main board (old) 10A. Also in this case, the communication from the main board (new) 10B to the sub board 20A is established without the need for user operation. As the result, the encrypted data 104A stored in the master nonvolatile memory 104 of the main board (old) 10A may be continuously used in the main board (new) 10B.

### Exemplary Embodiment 2

In Exemplary Embodiment 1, the backed-up encryption key 204A (see FIG. 2) is stored in the nonvolatile memory 204 mounted on the sub board 20A.

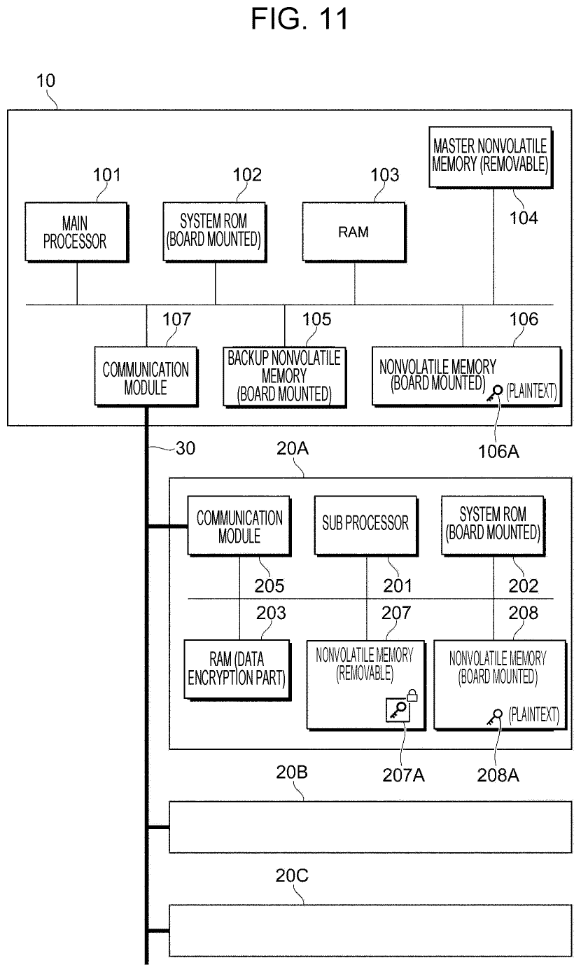

In contrast, in this exemplary embodiment, encryption key data 207A (see FIG. 11) is stored in a nonvolatile memory 207 (see FIG. 11) removable from the sub board 20A.

FIG. 11 is a view for explaining a different example internal configuration of the main board 10, the sub boards 20A, 20B, and 20C. The components illustrated in FIG. 11 are denoted by references corresponding to those in FIG. 2.

In FIG. 11, the nonvolatile memory 207 is removable from the sub board 20.

A plaintext encryption key is prohibited from being stored in a removable memory device. Accordingly, the nonvolatile memory 207 removable from the sub board 20 stores the encryption key data 207A in which the encryption key 106A is encrypted.

An encryption key 208A in a plaintext form used to generate the encryption key data 207A is stored in a nonvolatile memory 208 mounted on the sub board 20. The nonvolatile memory 208 satisfies the requirement that a memory device be different from the nonvolatile memory 207 storing the encryption key data 207A. In addition, the nonvolatile memory 208 is mounted on the sub board 20A and is thus allowed to store the plaintext encryption key 208A.

The encryption key data 207A is encrypted and decrypted by the data encryption part 103B1 (see FIG. 4) loaded into the RAM 203.

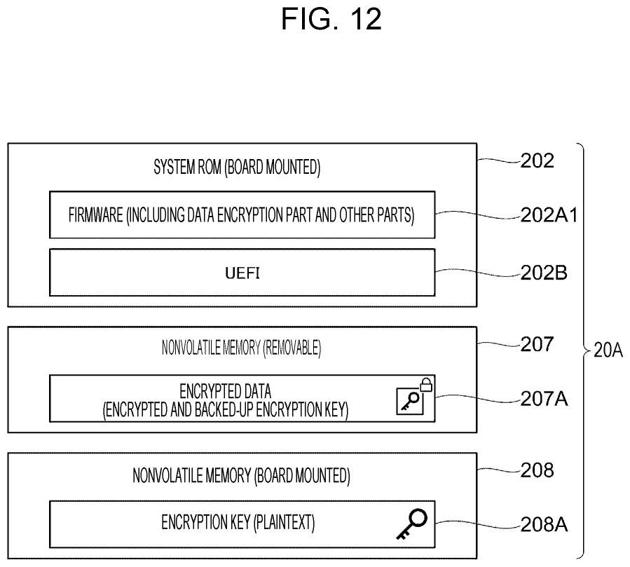

The data encryption part 103B1 that encrypts and decrypts the encryption key data 207A is included in firmware 202A1 stored in the system ROM 202 (see FIG. 12).

FIG. 12 is a view for explaining different example data stored in the memory device in the sub board 20A. The components illustrated in FIG. 12 are denoted by references corresponding to those in FIGS. 3 and 11. The data stored in the memory device in the main board 10 is the same as that in FIG. 3. Accordingly, the main board 10 is omitted in FIG. 12.

In FIG. 12, the system ROM 202 stores the firmware 202A1 and the UEFI 202B.

The firmware 202A1 in this exemplary embodiment includes functional programs corresponding to a data encryption part, an encryption-key management part, and a data input-output part. The data encryption part encrypts and decrypts the plaintext encryption key 106A (see FIG. 3) written (backed up) from the main board 10. The encryption-key management part manages the plaintext encryption key 208A stored in the nonvolatile memory 208 mounted on the sub board 20.

The plaintext encryption key 208A is used to encrypt and decrypt the encryption key 106A (see FIG. 11) used for the main board 10.

As described above, the encryption key 208A and the encryption key data 207A are stored in the respective different memory devices.

The encryption key data 207A is stored in the nonvolatile memory 207 removable from the sub board 20.

In this exemplary embodiment, in restoring the encryption key in step S113 (see FIG. 7), processing for decrypting the plaintext backed-up encryption key 204A (see FIG. 9) from the encryption key data 207A is performed. The other processings are the same as those in Exemplary Embodiment 1.

### Summing Up

Also in this exemplary embodiment, the encrypted data 104A stored in the master nonvolatile memory 104 of the main board (old) 10A may be used in the main board (new) 10B.

### Other Exemplary Embodiments

(1) The exemplary embodiments of the present disclosure have heretofore been described. The technical scope of the present disclosure is not limited to the scope of the exemplary embodiments described above. From the description of the scope of claims, it is apparent that the technical scope of the disclosure includes various modifications and improvements made to the exemplary embodiments.

(2) In the exemplary embodiments described above, the case where the customer engineer replaces the main board 10 (see FIG. 1) is exemplified; however, a user of the image forming apparatus 1 may replace the main board 10.

(3) In the exemplary embodiments described above, the backed-up encryption key 204A (see FIG. 2) for the main board 10 (see FIG. 1) is stored in the sub board 20A (see FIG. 1) that forms the control panel 11 (see FIG. 1). However, the backed-up encryption key 204A may be stored in the sub board 20B (see FIG. 1) of the print engine 12 (see FIG. 1), the sub board 20C (see FIG. 1) of the scanner 13 (see FIG. 1), or a different sub board.

(4) The sub board 20 described in the exemplary embodiments described above includes the sub processor 201, the system ROM 202, and the RAM 203. However, the sub board 20 does not have to include these components. In other words, the sub board 20 may include the nonvolatile memory 204 storing the plaintext backed-up encryption key 204A (see FIG. 2) and the communication module 205 only. Likewise, the sub board 20 may include the nonvolatile memory 207 storing the encrypted encryption key data 207A (see FIG. 11) and the communication module 205 only.

(5) In the exemplary embodiments described above, the case where the main board 10 of the image forming apparatus 1 (see FIG. 1) is replaced is exemplified; however, the target apparatus is not limited to the image forming apparatus 1. Any apparatus that stores encrypted user data in the master nonvolatile memory 104 (see FIG. 2) may serve as the target apparatus.

(6) In the exemplary embodiments described above, it is assumed that the encrypted data 104A stored in the master nonvolatile memory 104 of the main board (old) 10A is taken over to the new main board (new) 10B. However, how the takeover above is performed may be applied to the takeover of the encrypted data stored in the failed sub board (old) 20 to the new sub board (new) 20. This case premises that encrypted data is stored in a nonvolatile memory removable from the sub board 20 and that an encryption key used for the encryption of the data is stored in the main board 10.

(7) In the exemplary embodiments described above, the communication method conforming to the I2C standard is used for the communication between the main board 10 and the sub board 20. However, a serial communication method based on universal asynchronous receiver transmitter (UAR), USB, peripheral component interconnect express (PCIe), or the like may be used for the communication between the main board 10 and the sub board 20.

(8) In the exemplary embodiments described above, the encrypted and backed-up data 105A (see FIG. 3) is restored to the master nonvolatile memory 104 (see FIG. 3) after the backed-up encryption key (old) 204A (see FIG. 3) is restored from the sub board 20. However, the encrypted and backed-up data 105A may be encrypted again with the encryption key (new) 106A unique to the main board (new) 10B after the encrypted and backed-up data 105A is decrypted with the restored backed-up encryption key 204A.

In this case, the encrypted data 104A generated through the re-encryption may be resorted to the master nonvolatile memory 104. In this case, the encrypted data 104A generated through the re-encryption is stored also in the backup nonvolatile memory 105 as new encrypted and backed-up data 105A.

The encryption key (old) 106A may be deleted, and only the encryption key (new) 106A may be stored in the main board 10 and the sub board 20.

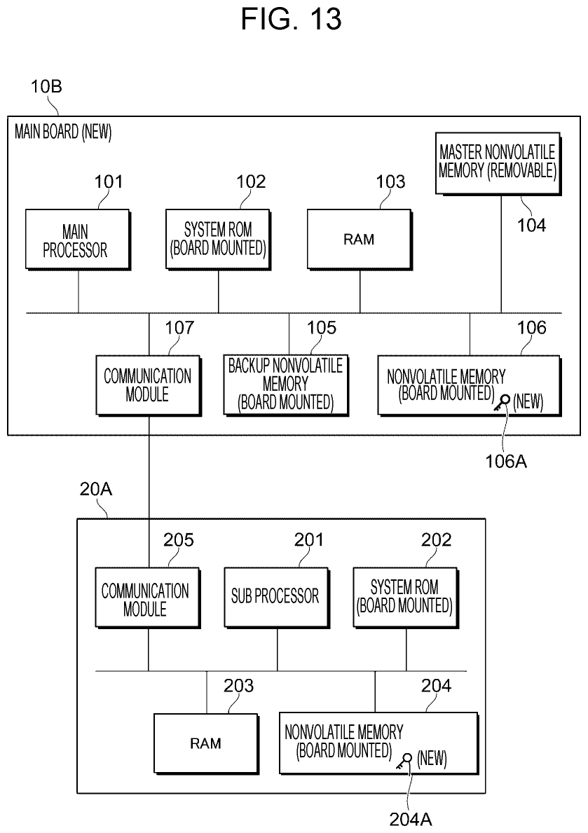

FIG. 13 is a view for explaining storing the encryption key 106A and the backed-up encryption key 204A in the case where the encrypted data 104A encrypted with the encryption key (new) 106A unique to the new main board (new) 10B is stored in the master nonvolatile memory 104. The components illustrated in FIG. 13 are denoted by references corresponding to those in FIG. 10.

In FIG. 13, the nonvolatile memory 106 and the nonvolatile memory 204 respectively store the encryption key (new) 106A unique to the main board (new) 10B and the backed-up encryption key 204A only.

(9) In the exemplary embodiments, the processes are performed by any computer. The computer may perform the processes by using a processor serving as hardware, a program serving as software, or combination of these.

In this case, the processor is configured to perform the processes in the exemplary embodiments in cooperation with the program and may function as a unit or a means in the exemplary embodiments.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage).

The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

(10) The present disclosure is also applicable to a program and a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing apparatus includes a first board and a second board, the first board and the second board being connected via a communication line, the first board including a first processor, a first memory device that is removable, and a second memory device that is not removable, the first memory device being a memory device moved from a third board that has undergone replacement with the first board, the first memory device storing first encrypted data encrypted with a first encryption key unique to the third board, the second board including a second processor and a third memory device, the third memory device storing the first encryption key backed up before the replacement of the third board with the first board, the first processor being configured to: in response to a failure in communication between the first board and the second board, copy the first encrypted data from the first memory device into the second memory device; initialize the first memory device and write, to the first memory device, parameter information required for the communication with the second board; establish the communication with the second board by using the parameter information; and acquire the first encryption key from the second board with which the communication is established and store the first encryption key in the first board.

(((2)))

In the information processing apparatus according to (((1))), the communication line is provided for synchronous serial communication.

(((3)))

In the information processing apparatus according to (((2))), the synchronous serial communication is inter integrated circuit (I2C) communication.

(((4)))

In the information processing apparatus according to any one of (((1))) to (((3))), the first board is a main board, and the second board is a sub board.

(((5)))

In the information processing apparatus according to any one of (((1))) to (((3))), the first board is a sub board, and the second board is a main board or a different sub board.

(((6)))

In the information processing apparatus according to (((4))) or (((5))), the sub board is a user interface board, a board of an image output unit, or a board of an image reading unit.

(((7)))

In the information processing apparatus according to any one of (((1))) to (((6))), the first processor is configured to: store the first encryption key in the first board and thereafter write, to the initialized first memory device, the first encrypted data copied into the second memory device.

(((8))) In the information processing apparatus according to any one of (((1))) to (((6))), the first processor is configured to: decrypt the first encrypted data stored in the second memory device by using the first encryption key; and encrypt data acquired by decrypting the first encrypted data and store the data in the first memory device, the data being encrypted by using a second encryption key unique to the first board.
(((9)))

A program causes a first processor of an information processing apparatus to execute a process, the information processing apparatus including a first board and a second board, the first board and the second board being connected via a communication line, the first board including a first processor, a first memory device that is removable, and a second memory device that is not removable, the first memory device being a memory device moved from a third board that has undergone replacement with the first board, the first memory device storing first encrypted data encrypted with a first encryption key unique to the third board, the second board including a second processor and a third memory device, the third memory device storing the first encryption key backed up before the replacement of the third board with the first board, the process including: in response to a failure in communication between the first board and the second board, copying the first encrypted data from the first memory device into the second memory device; initializing the first memory device and writing, to the first memory device, parameter information required for the communication with the second board; establishing the communication with the second board by using the parameter information; and acquiring the first encryption key from the second board with which the communication is established and storing the first encryption key in the first board.

What is claimed is:

1. An information processing apparatus comprising:
a first board; and a second board, the first board and the second board being connected via a communication line,
the first board including a first processor, a first memory device that is removable, and a second memory device that is not removable,
the first memory device being a memory device moved from a third board that has undergone replacement with the first board,
the first memory device storing first encrypted data encrypted with a first encryption key unique to the third board,
the second board including a second processor and a third memory device,
the third memory device storing the first encryption key backed up before the replacement of the third board with the first board,
the first processor being configured to:
in response to a failure in communication between the first board and the second board,
copy the first encrypted data from the first memory device into the second memory device;
initialize the first memory device and write, to the first memory device, parameter information required for the communication with the second board;
establish the communication with the second board by using the parameter information; and
acquire the first encryption key from the second board with which the communication is established and store the first encryption key in the first board.

2. The information processing apparatus according to claim 1,
wherein the communication line is provided for synchronous serial communication.

3. The information processing apparatus according to claim 2,
wherein the synchronous serial communication is inter integrated circuit (I2C) communication.

4. The information processing apparatus according to claim 1,
wherein the first board is a main board, and the second board is a sub board.

5. The information processing apparatus according to claim 1,
wherein the first board is a sub board, and the second board is a main board or a different sub board.

6. The information processing apparatus according to claim 4,
wherein the sub board is a user interface board, a board of an image output unit, or a board of an image reading unit.

7. The information processing apparatus according to claim 5,
wherein the sub board is a user interface board, a board of an image output unit, or a board of an image reading unit.

8. The information processing apparatus according to claim 1,
wherein the first processor is configured to:
store the first encryption key in the first board and thereafter write, to the initialized first memory device, the first encrypted data copied into the second memory device.

9. The information processing apparatus according to claim 1,
wherein the first processor is configured to:
decrypt the first encrypted data stored in the second memory device by using the first encryption key; and
encrypt data acquired by decrypting the first encrypted data and store the data in the first memory device, the data being encrypted by using a second encryption key unique to the first board.

10. A non-transitory computer readable medium storing a program causing a first processor of an information processing apparatus to execute a process, the information processing apparatus including:
a first board; and a second board, the first board and the second board being connected via a communication line,
the first board including a first processor, a first memory device that is removable, and a second memory device that is not removable,
the first memory device being a memory device moved from a third board that has undergone replacement with the first board,
the first memory device storing first encrypted data encrypted with a first encryption key unique to the third board,
the second board including a second processor and a third memory device,
the third memory device storing the first encryption key backed up before the replacement of the third board with the first board,
the process comprising:
in response to a failure in communication between the first board and the second board,
copying the first encrypted data from the first memory device into the second memory device;
initializing the first memory device and writing, to the first memory device, parameter information required for the communication with the second board;
establishing the communication with the second board by using the parameter information; and
acquiring the first encryption key from the second board with which the communication is established and storing the first encryption key in the first board.

11. An information processing method for a first processor of an information processing apparatus including:
a first board; and a second board, the first board and the second board being connected via a communication line,
the first board including a first processor, a first memory device that is removable, and a second memory device that is not removable,
the first memory device being a memory device moved from a third board that has undergone replacement with the first board,
the first memory device storing first encrypted data encrypted with a first encryption key unique to the third board,
the second board including a second processor and a third memory device,
the third memory device storing the first encryption key backed up before the replacement of the third board with the first board,
the method comprising:
in response to a failure in communication between the first board and the second board,
copying the first encrypted data from the first memory device into the second memory device;
initializing the first memory device and writing, to the first memory device, parameter information required for the communication with the second board;
establishing the communication with the second board by using the parameter information; and
acquiring the first encryption key from the second board with which the communication is established and storing the first encryption key in the first board.
